(19) United States
(12) Patent Application Publication
(10) Pub. No.: US 2006/0056427 A1
(43) Pub. Date: Mar. 16, 2006

(54) Multicast communication method and gateway apparatus

(75) Inventor: Junji Sato, Tokyo (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/115,289

(22) Filed: Apr. 27, 2005

(30) Foreign Application Priority Data
Aug. 31, 2004 (JP) JP2004-252012

(51) Int. Cl. H04L 12/56

(52) U.S. Cl. 370/401

(57) ABSTRACT

A gateway apparatus on a receiving side, which controls a receiver terminal, sends a tunnel connection request message to a gateway apparatus on a sending side that controls a sender terminal where multicast packet broadcasting originate. In contrast, the gateway apparatus on the sending side that has received the tunnel connection request message establishes a virtual communication path for transferring a multicast packet to the gateway apparatus on the receiving side.

### BACKGROUND OF THE INVENTION

1. Field of the Invention

The present invention relates to a multicast communication method and a gateway apparatus that enable multicast communication in a communication format of 1:n on a network.

2. Description of Related Art

Multicast communication exists as a way to achieve a 1:n type communication format that only sends information to a host belonging to a specific group. Multicast communication is seen to have potential as a way to broadcast multimedia content and for group communication. Applications are also being developed using multicast communication for group communication (for example, refer to Related Art 1).

[Related Art 1] Japanese Patent Laid-open Publication 2003-069547

However, when broadcasting a multicast packet, all routers in the relay path must be able to process the multicast. A protocol must also be implemented to exchange multicast routing information. Because of this, it was difficult to establish an actual multicast network.

### SUMMARY OF THE INVENTION

The present invention addresses the above-described problems. The purpose of the invention is to provide a multicast communication method and a gateway apparatus that can simply establish a multicast network without having all routers in a relay path processing the multicast and without implementing a protocol to exchange multicast routing information in all routers.

In the present invention, a gateway apparatus on a receiving side, which controls a receiver terminal, sends a tunnel connection request message to a gateway apparatus on a sending side that controls a sender terminal where multicast packet broadcasting originate. In contrast, the gateway apparatus on the sending side that has received the tunnel connection request message establishes a virtual communication path for transferring a multicast packet to the gateway apparatus on the receiving side.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 illustrates a network configuration according to an embodiment of the present invention;

FIG. 2 illustrates a hardware configuration of HGW (A) or (B) according to the embodiment;

FIG. 3 illustrates a sequence related to establishing a tunnel connection according to the embodiment;

FIG. 4 is a flowchart illustrating Join (S, G) receiving process of HGW (B) according to the embodiment;

FIG. 5 is a conceptual illustration of an interface receiver information list according to the embodiment;

FIG. 6 illustrates a configuration of a tunnel control information table according to the embodiment;

FIG. 7 is a flowchart illustrating Register (HGW B, S, G) receiving process of HGW (A) according to the embodiment;

FIG. 8 illustrates a state of a tunnel header and unicast header during multicast communication according to the embodiment;

FIG. 9 illustrates a sequence related to releasing a tunnel connection according to the embodiment;

FIG. 10 is a flowchart illustrating Leave (S, G) receiving process of HGW (B) according to the embodiment; and

FIG. 11 is a flowchart illustrating Deregister (HGW B, S, G) receiving process of HGW (A) according to the embodiment.

### DETAILED DESCRIPTION OF PREFERRED EMBODIMENTS

The embodiments of the present invention are explained in the following, in reference to the above-described drawings. In the following, a system is described in which the multicast communication method and the gateway apparatus according to an embodiment of the present invention are applied.

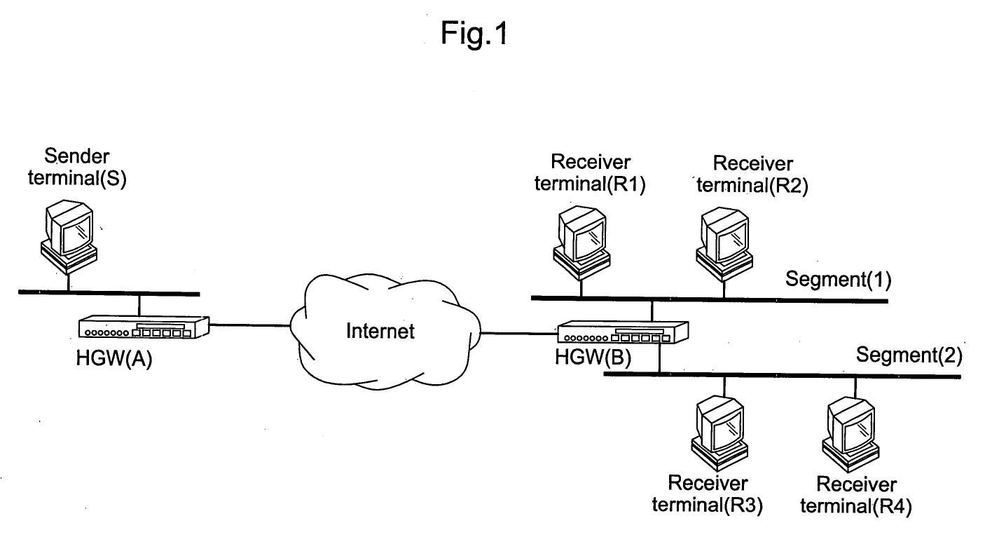

FIG. 1 is a network configuration according to the present embodiment. In this figure, sender terminal (S) is under the control of gateway apparatus (hereafter referred to as HGW) (A) and receiver terminals (R1) to (R4) are under the control of HGW (B). Receiver terminals (R1) and (R2) belong to segment (1) and receiver terminals (R3) and (R4) belong to segment (2). Both sender terminal (S) and receiver terminals (R1) to (R4) are communication terminals configured with, for example, a personal computer. In this example, the names are changed for sake of convenience in order to distinguish the sending side and the receiving side in multicast communication.

The communication path between HGW (A) and HGW (B) is configured with an Internet having multiple routers. In this embodiment, the routers provided between HGW (A) and HGW (B) do not process multicast while sender terminal (S) can multicast to receiver terminals (R1) to (R4). In particular, an “MLD proxy function” is applied, the function transferring an MLD (Multicast Listener Discovery) protocol to HGW (A) and HGW (B) (edge routers of ISP), in order to establish a virtual communication path (tunnel) that allows IPv6 multicast data and to transfer between HGW (A) and HGW (B) and to transfer IPv6 multicast data through that tunnel.

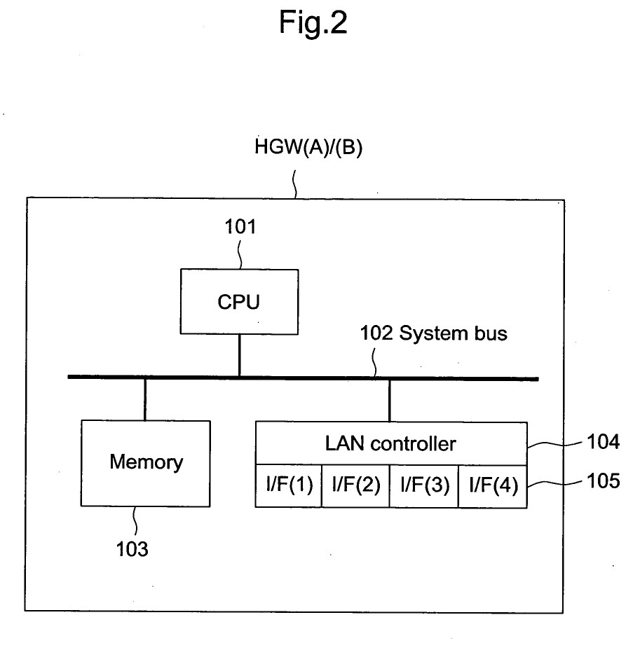

FIG. 2 is a hardware configuration of HGW (A) or (B). In HGW (A), CPU 101 is connected to memory 103 and LAN controller 104 through system bus 102. CPU 101 executes each control of establishing a tunnel, executing multicast communication, and releasing a tunnel by retrieving and executing control programs stored in memory 103. Memory 103 includes a storage medium such as a ROM that stores programs and a RAM used as a work area. A tunnel control information table (described later) is stored in memory 103. In addition, an interface sender information list is provided in memory 103 of HGW (B) that controls the sender terminal. LAN controller 104 controls LAN interface module 105 that includes a plurality of interfaces I/F (1) to I/F (4). Each segment or terminal of an external network is connected to each interface I/F (1) to I/F (4). HGW (A) is an ISP edge router to which sender terminal (S) belongs. The basic configuration of HGW (B) is the same as HGW (A).

Next, the operation of an embodiment configured in this manner is described in detail.

In this embodiment, a tunnel connection is established and released by defining a tunnel connection request message [Register] and a tunnel release request message [Deregister] and by exchanging these two messages between HGWs (A) and (B). [Register] is a message sent from HGW (B) to HGW (A), that controls sender terminal (S), when a multicast reception request message (Join) is received from receiver terminal (Ri) that is under the control of HGW (B). Exchanging [Register] between HGWs (A) and (B) makes it possible to establish a tunnel connection and transfer IPv6 multicast data. In contrast, [Deregister] is a message that is sent when HGW (B) receives a multicast stop request message (Leave) from receiver terminal (Ri) under control. Exchanging [Deregister] between HGWs (A) and (B) releases the tunnel connection and stops the transfer of the IPv6 multicast data. The above description is an outline of the tunnel connection establishment method.

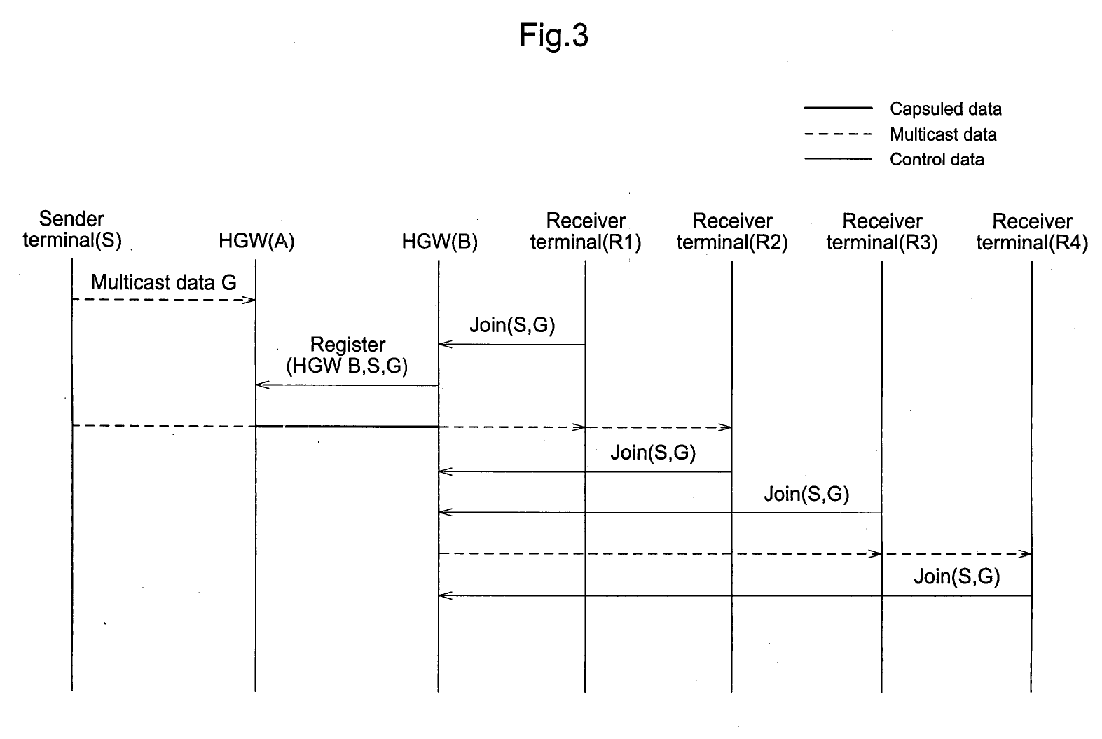

FIG. 3 is a sequence that sends [Register] from HGW (B) to HGW (A) and transfers IPv6 multicast data. Although a multicast packet sent by sender terminal (S) is retrieved by HGW (A) and the path selected, in the initial stage, a virtual communication path (tunnel) is not established between HGWs (A) and (B). Therefore, no data is transferred to HGW (B).

In contrast, when sender terminal (R1) receives a broadcast of multicast data of multicast address (G) with the source being sender terminal (S), Join (S, G) is sent to HGW (B). Join (S, G) is a message that requests receipt of multicast data of sender terminal (S) with the source being multicast address (G).

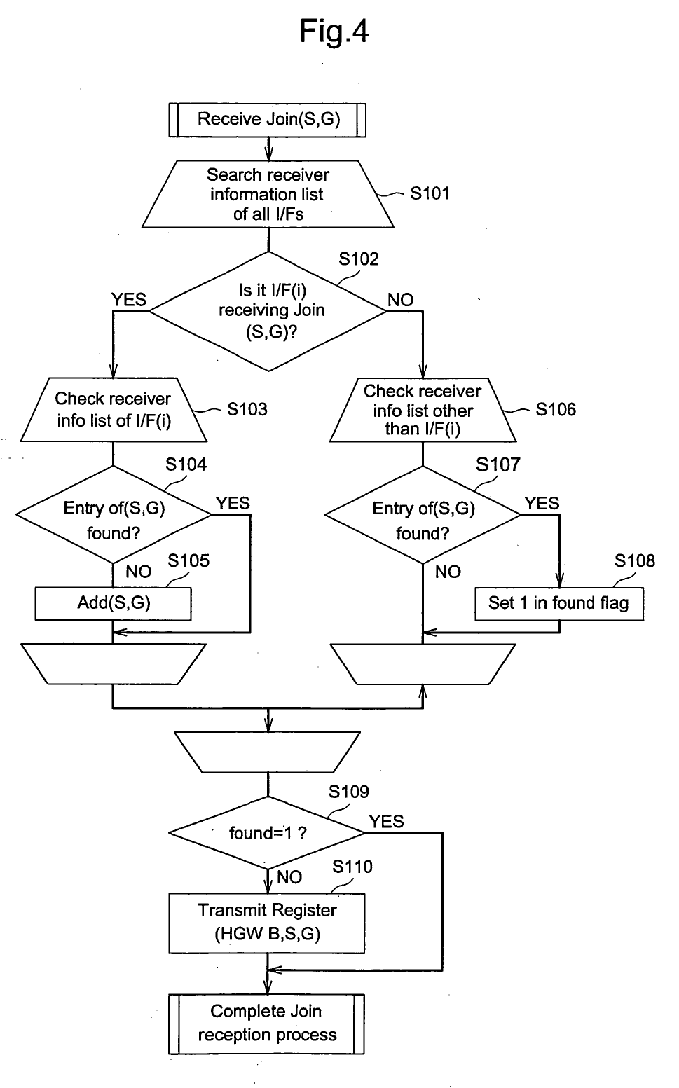

FIG. 4 is a flowchart illustrating an operation of HGW (B) that has received Join (S, G). When HGW (B) receives Join (S, G) from receiver terminal (Ri) under control, interface receiver information lists are searched for all interfaces to determine whether to send Register (HGW B, S, G).

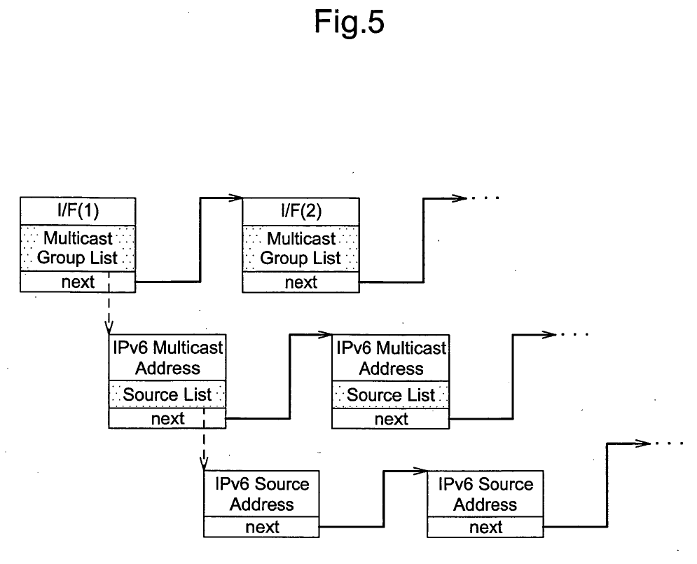

The interface receiver information list is hereafter described. An interface receiver information list is created for each interface I/F (1) to (4). FIG. 5 is a conceptual illustration of an interface receiver information list. In this figure, an interface receiver information list is created for each interface I/F. The interface receiver information list includes a “multicast group list” and a “source list” for each multicast group. A multicast group is specified by a multicast address and a source list is specified by an IP address of sender terminal (S). One receiver terminal can also belong to a plurality of multicast groups. Entries are only created for the number of participating multicast groups and entries with identical content are not repeatedly registered for one interface I/F (i).

HGW (B) that has received a Join (S, G) searches the interface receiver information lists in order from interface I/F (1) to interface I/F (4) (S101).

At this point Join (S, G) is received by interface I/F (i). When the interface of the search target at S101 is interface I/F (i) that has received Join (S, G) (S 102), the interface receiver information list registered in interface I/F (i) is checked in order (S103). As a result, when there is no entry (S, G) in any of the interface receiver information lists (S104), entry (S, G) is added to the interface I/F (i) (S 105). When entry (S, G) already exists in any of the interface receiver information lists, the entry is not added.

In contrast, when it is determined at S102 that the interface of the search target is an interface other than one that has received Join (S, G), the interface receiver information lists registered in the interface I/F are checked in order (S106). When entry (S, G) is registered in any of the interface receiver information lists (S107), the detection flag (found) is set to 1 (S108). The above process repeats for all interfaces I/F other than the interface that has received Join (S, G).

When the above process completes for all interfaces I/F (1) to (4), it is determined whether the detection flag is set to 1 (S109). Only when the detection flag is not set to 1, Register (HGW B, S, G) is sent (S110).

The fact that the identical entry (S, G) already exists in an interface receiver information list means that HGW (B) has established a tunnel connection, which is a virtual communication path for (S, G) between HGW (A). Therefore, even when a new tunnel is not established, HGW (B) can receive multicast data whose destination is multicast address (G) from HGW (A) with the source being sender terminal (S). In particular, as shown in the sequence of FIG. 3, a tunnel connection is established for (S, G) between HGW (A) and HGW (B) by a Join (S, G) initially generated by receiver terminal (R1). Thereafter, receiver terminals (R2), (R3), and (R4) send Join (S, G) to HGW (B) although Register (HGW B, S, G) is no longer generated upon receiving these requests.

In contrast, HGW (A) that has received Register (HGW B, S, G) establishes a tunnel connection between HGW (B).

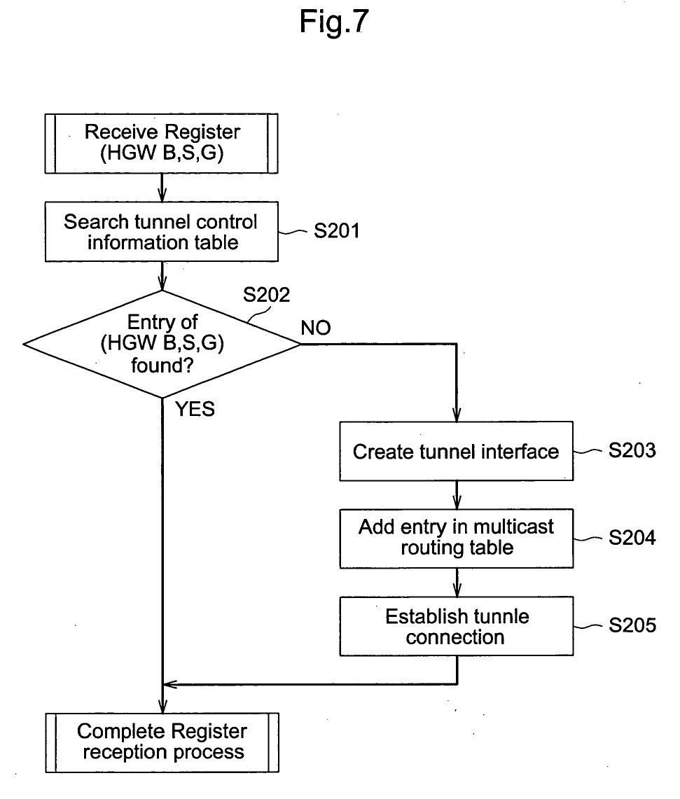

FIG. 7 is a flowchart illustrating an operation when HGW (A) receives Register (HGW B, S, G). As shown in this figure, HGW (A) searches a tunnel control information table (S201).

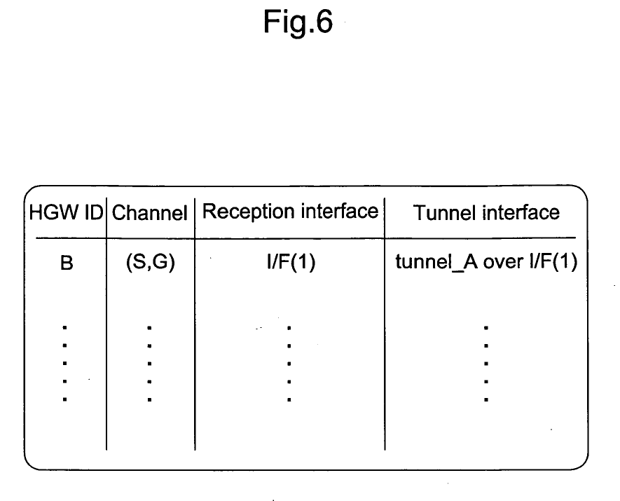

Here, the configuration of a tunnel control information table is described. As shown in FIG. 6, a tunnel control information table configures one entry that includes an “HGW ID” indicating identification information of a gateway apparatus (transfer destination for multicast data), a “channel” being a combination of an IP address of sender terminal (S) (source of the multicast data) and a multicast address (G) (destination), a “receiving interface” indicating the interface that has received [Register] (entry creation opportunity), and a “tunnel interface” realizing an established tunnel in a specified format.

When the result of searching the tunnel control information table finds an existing entry (HGW B, S, G), it indicates that a tunnel connection requested by the current Register (HGW B, S, G) has already been established. Therefore, the reception process ends.

In contrast, when entry (HGW B, S, G) does not exist (S202), an operation to establish a tunnel connection is started. At first, a tunnel interface is created on interface I/F (i) that has received Register (HGW B, S, G), the tunnel interface having HGW (B) as the destination (S203). In more detail, as shown in FIG. 6, an entry whose content includes HGW ID=B, channel=(S, G), receiving interface=I/F (1) (when Register (HGW B, S, G) is received by interface I/F (1) of HGW (A)), and tunnel interface=tunnel A over I/F I is written into the tunnel control information table.

Next, an entry is added to a multicast routing table to send multicast packets with a source address of S and a destination address of G to a tunnel device (HGW (B) acting as a gateway apparatus on the receiving side) (S204). Creating a tunnel interface and adding an entry to the multicast routing table establishes a tunnel connection (S205).

As described above, entry (S, G) is written into the interface receiver information list of HGW (B), based on Join (S, G) received from receiver terminal (R1), while a tunnel interface, having HGW (B) as the destination, is created in a tunnel information control table of HGW (A). In addition, an entry that transfers specific multicast data to HGW (B) is added to a multicast routing table.

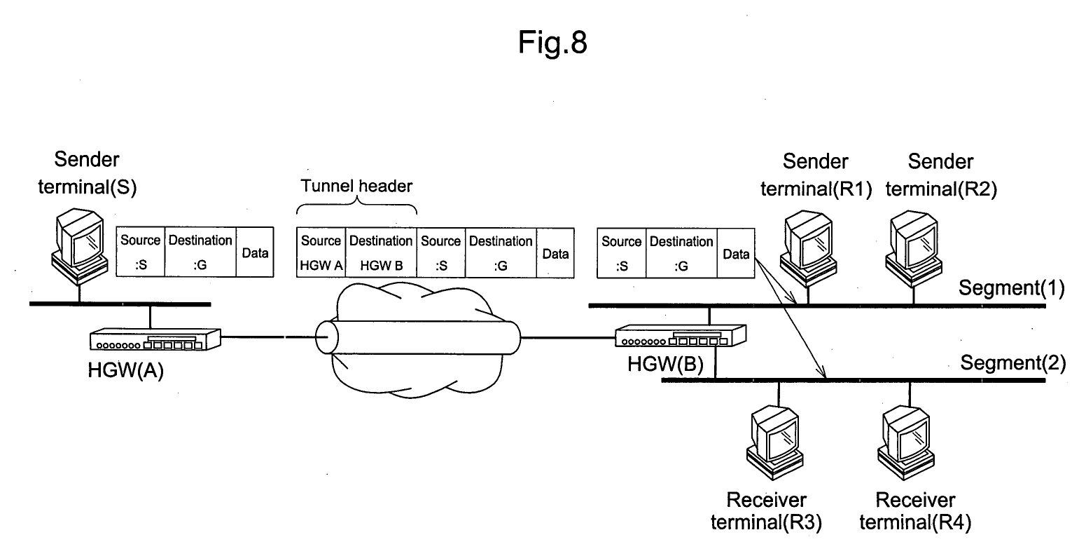

FIG. 8 illustrates a state where a tunnel connection is established between HGW (A) and HGW (B), in which multicast data sent by sender terminal (S) is received by receiver terminals (R1) to (R4) on segments 1 and 2 connected to HGW (B). As shown in this figure, sender terminal (S) generates a packet including “S” for the source address and “G” (multicast address) for the destination address and sends the packet out onto a network of segments belonging to sender terminal (S) itself. HGW (A) retrieves the packet, examines the destination in the packet header and identifies it as multicast data. By referencing the multicast routing table, the packet with S as the source address and G as the destination address is transferred to HGW (B) as well as to the tunnel device by the specified control of an entry. In other words, a tunnel header (unicast header) with a destination of HGW (B) is attached to the multicast packet and capsulated. The capsulated multicast data is then sent from interface I/F (1) out onto the network.

Here, the tunnel header is a header used for unicast, having the IP address of HGW (A) as the source and the IP address of HGW (B) as the destination address. Therefore, the multicast data is capsulated and made into a unicast by a tunnel header from HGW (A) to HGW (B). This makes it possible to transfer multicast data (with a unicast header attached) to HGW (B) through the network without the routers in the path extending from HGW (A) to HGW (B) processing the multicast.

HGW (B) can process multicast. When multicast address (G) is detected from a received packet retrieved from the Internet, the multicast routing table is referenced in determining the segment of the transfer destination. In other words, interface I/F (i) having multicast address (G) in the multicast routing table is detected, and the received packet is sent to interface I/F (i).

The sequence shown in FIG. 3 is described in detail. In this sequence, segment 1 to which receiver terminal (R1) belongs connects to interface I/F (1) of HGW (B) and segment 2 connects to interface I/F (1) of HGW (B). HGW (B) has already received Join (S, G) from receiver terminal (R1) in advance and the multicast routing table has a setting where the received packet of multicast address (G) is to be sent out to interface I/F (1). In this case, because the received packet of multicast address (G) is sent out to interface I/F (1) as shown in FIG. 3, the received packet of multicast address (G) is sent to receiver terminals (R1) and (R2), which belong to segment 1.

At this time, receiver terminal (R3) that belongs to segment 2 does not notify HGW (B) of Join (S, G). Because of this, the received packet of multicast address (G) is not sent out to segment 2. After this, receiver terminal (R3) that belongs to segment 2 notifies HGW (B) of Join (S, G) in the sequence shown in FIG. 3. At the moment when HGW (B) receives Join (S, G) from receiver terminal (R3), a tunnel connection that corresponds to Join (S, G) is already established. Consequently, it is not preferable to notify HGW (A) of Register (HGW B, S, G), because it is the same message. In contrast, the multicast routing table of HGW (B) must be set such that the received packet of multicast address (G) is sent to segment 2. As shown in FIG. 3, the result of setting the multicast routing table of HGW (B) in this manner is to send out the received packet of multicast address (G) to receiver terminals (R3) and (R4) of segment 2.

Next, the operation is described when releasing the tunnel connection established between HGW (A) and HGW (B). In this embodiment, HGW (B) that has received a multicast stop request message (Leave) from a receiver terminal sends Deregister to HGW (A). When Deregister is exchanged between HGW (A) and HGW (B), the tunnel connection is released, and the transfer of IPv6 multicast data is stopped.

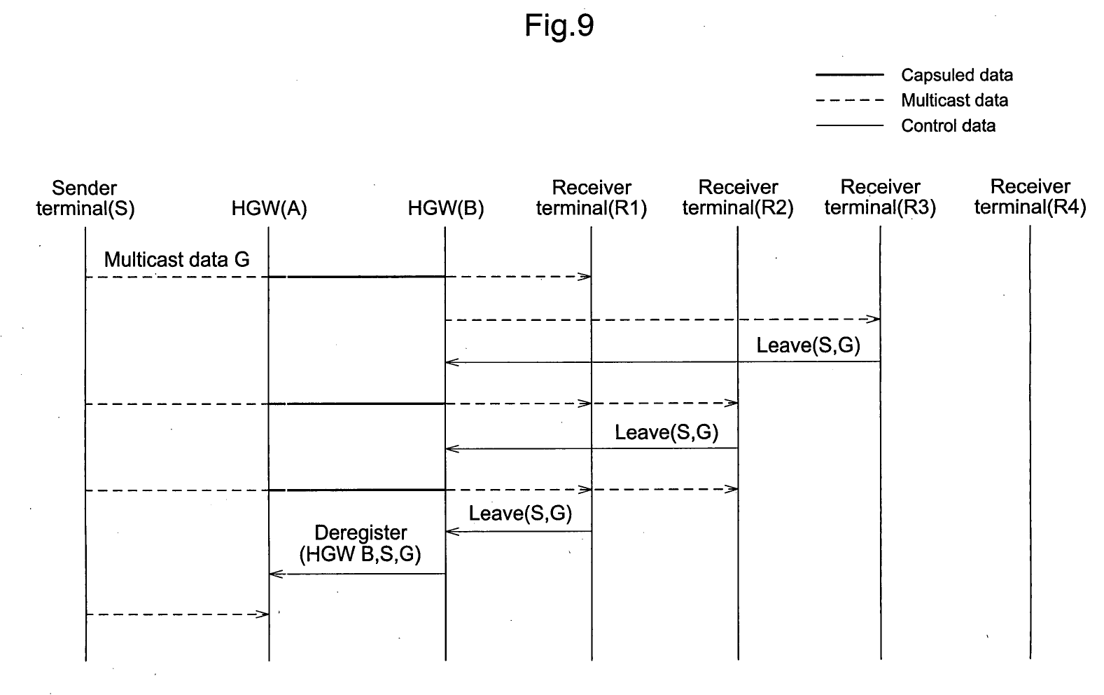

FIG. 9 is an example of a sequence when releasing a tunnel connection established between HGW (A) and HGW (B). With a tunnel connection for (S, G) established between HGW (A) and HGW (B), receiver terminal (R3) notifies HGW (B) of Leave (S, G).

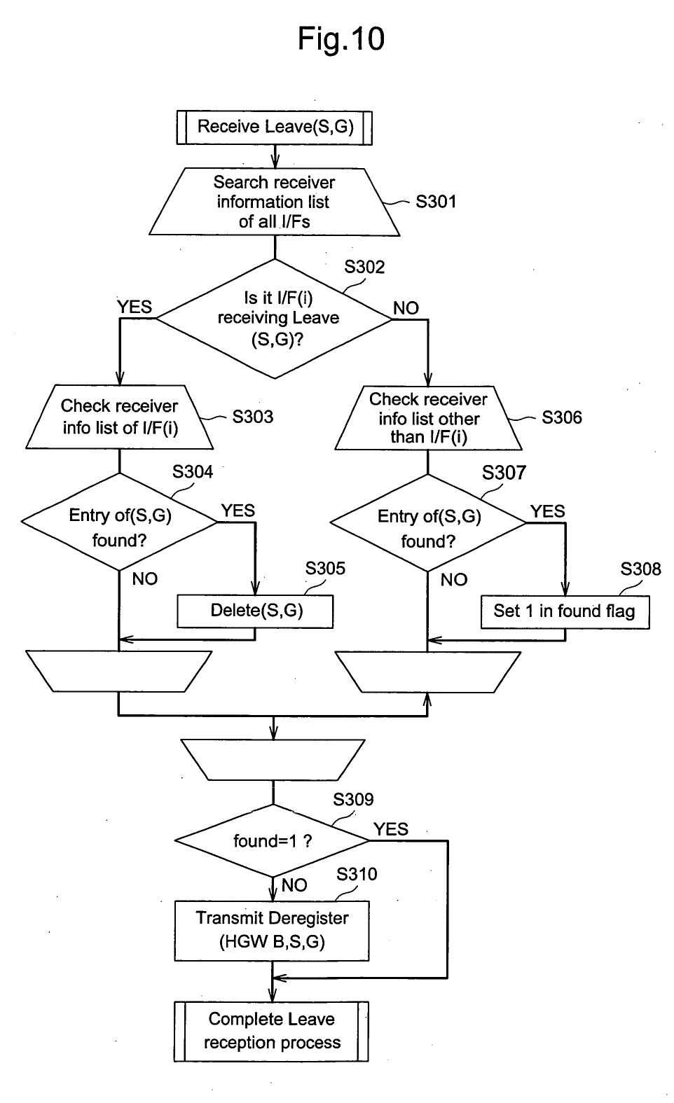

FIG. 10 is a flowchart of HGW (B) that receives Leave (S, G). When HGW (B) receives Leave (S, G), it is determined whether another receiver terminal exists that is participating in the multicast (S, G). When another participating receiver terminal exists, HGW (A) is notified of Deregister (HGW B, S, G) and the tunnel connection for (S, G) is released.

HGW (B) that has received Leave (S, G) searches the interface receiver information list in order from interface I/F (1) (S301).

In this example, Leave (S, G) is received by interface I/F (i). When the interface of the search target at S301 is interface I/F (i) that has received Leave (S, G) (S302), the interface receiver information lists registered in interface I/F (i) are checked in order (S303). As a result, when there is entry (S, G) in any of the interface receiver information lists (S304), entry (S, G) is deleted from interface I/F (i) (S305).

In contrast, when it is determined at S302 that the interface of the search result is an interface other than one that has received Leave (S, G), the interface receiver information lists registered in the interface I/F is checked in order (S306). When entry (S, G) is registered in any of the interface receiver information lists (S307), the detection flag (found) is set to 1 (S308). The above process repeats for all interfaces I/F other than the interface that has received Leave (S, G).

When the above process completes for all interface I/F (1) to (4), it is determined whether the detection flag is set to 1 (S309). Only when the detection flag (found) is not set to 1, Deregister (HGW B, S, G) is sent (S310).

Although receiver terminal (R3) has generated a multicast stop request in this manner, when other receiver terminals exist that utilize the tunnel connection between HGW (A) and HGW (B) for multicast communication, the tunnel connection is maintained. When a receiver terminal participating in (S, G) until the end generates a multicast stop request (Leave), the tunnel connection for (S, G) is released. This makes it possible to prevent problems of the transfer of multicast data being stopped due to the tunnel connection being released regardless of whether other receiver terminals are using multicast communication.

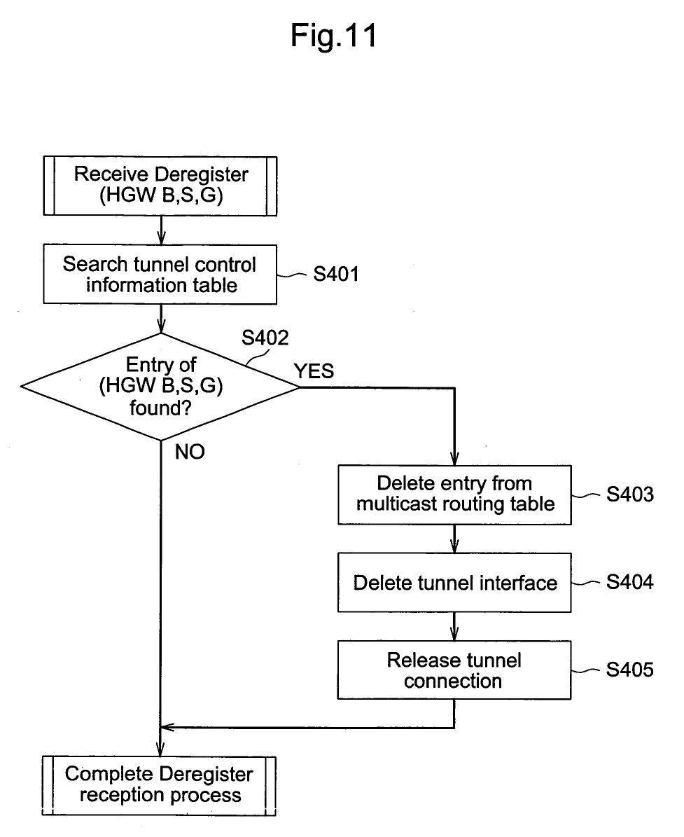

FIG. 11 is a flowchart to release a tunnel connection by HGW (A) that has received Deregister (HGW B, S, G).

When HGW (A) receives Deregister (HGW B, S, G), the tunnel control information table is searched (S401). Then, it is determined whether entry (HGW B, S, G) exists in the tunnel control information table (S402). The determination can be made from whether identical entry exists from the combination of “HGW ID” and “channel” in the tunnel control information table. When it is determined at S402 that entry (HGW B, S, G) exists, an entry that also sends the packet to HGW (B) is deleted from the multicast routing table of HGW (A), the packet having “S” as the source address and “G” as the destination address (S403). Next, the tunnel interface that corresponds to (HGW B, S, G) is deleted (S404). This is receiving interface I/F (i) that has received Deregister (HGW B, S, G) from the tunnel control information table and is realized by deleting the entry where the tunnel interface, having HGW (B) as the destination, is registered. The tunnel connection is released in this manner (S405) and the Deregister reception process ends.

As a result, the tunnel connection for (S, G) established between HGW (A) and HGW (B) is released. Therefore, as shown in FIG. 9, the capsulated multicast data G is no longer transferred to HGW (B).

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2004-252012 filed on Aug. 31, 2004, entire content of which is expressly incorporated by reference herein.

What is claimed is:

1. A multicast communication method comprising:
transmitting a tunnel connection request message from a receiver gateway apparatus to a sender gateway apparatus, the receiver gateway apparatus having a receiver terminal under control, the sender gateway apparatus having a sender terminal under control, the sender terminal being a source of a multicast packet; and
establishing, upon receiving the tunnel connection request message, a virtual communication path for transferring the multicast packet from the sender gateway apparatus to the receiver gateway apparatus.

2. The multicast communication method according to claim 1, further comprising:
receiving, at the receiver gateway apparatus, a multicast reception request from the receiver terminal under control; and
registering an entry only when an identical entry does not exist in a receiver information list in an interface that has received the multicast reception request, the entry specifying a multicast address and the sender terminal, wherein,
when the multicast reception request is received, receiver information lists of all interfaces are searched, and wherein,
when the identical entry is not found in the receiver information lists, the tunnel connection request message is transmitted.

3. The multicast communication method according to claim 1, further comprising:
generating a tunnel interface by the sender gateway apparatus that has received the tunnel connection request message, the tunnel interface having the receiver gateway apparatus as a destination, the receiver gateway apparatus being a source of the tunnel connection request message; and
adding an entry to a multicast routing table, the entry also transmitting the multicast packet to the receiver gateway apparatus, the multicast packet having the sender terminal as a source address and the multicast address as a sending address.

4. A multicast communication method comprising:
transmitting a tunnel release request message from a receiver gateway apparatus to a sender gateway apparatus, the receiver gateway apparatus having a receiver terminal under control, the sender gateway apparatus having a sender terminal under control, the sender terminal being a source of a multicast packet; and
erasing, upon receiving the tunnel release request message, a virtual communication path for transferring the multicast packet from the sender gateway apparatus to the receiver gateway apparatus.

5. The multicast communication method according to claim 4, further comprising:
receiving, at the receiver gateway apparatus, a multicast stop request from the receiver terminal under control; and
deleting an entry only when a participant having an identical entry does not exist on an interface that has received the multicast stop request, wherein, when the multicast stop request is received, receiver information lists of all interfaces are searched, and wherein,
when the identical entry is not found in the receiver information lists, the tunnel release request message is transmitted.

6. The multicast communication method according to claim 4, further comprising:
deleting a tunnel interface by the sender gateway apparatus that has received the tunnel release request message, the tunnel interface having the receiver gateway apparatus as a destination, the receiver gateway apparatus being a source of the tunnel release request message; and
deleting an entry from a multicast routing table, the entry also transmitting the multicast packet to the receiver gateway apparatus, the multicast packet having the sender terminal as a source address and the multicast address as a sending address.

7. The multicast communication method according to claim 1, wherein, in the virtual communication path, the multicast packet is capsulated using a unicast packet and transmitted to the receiver gateway apparatus.

8. A gateway apparatus comprising:
a memory that stores a control program;
a processor that retrieves the control program from said memory and executes the control program; and
a plurality of interfaces to which a segment and an external network is connected, the segment having a receiver terminal controlled by the gateway apparatus, wherein said processor registers, upon receiving a multicast reception request from the receiver terminal under control, an entry only when an identical entry does not exist in a receiver information list in an interface that has received the multicast reception request, the entry specifying a multicast address and a sender terminal, and wherein,
after searching receiver information lists of all interfaces and when the identical entry is not found in the receiver information lists, said processor transmits a tunnel connection request message to a sender gateway apparatus that has the sender terminal under control.

9. A gateway apparatus comprising:
a memory that stores a control program;
a processor that retrieves the control program from said memory and executes the control program; and
a plurality of interfaces to which a segment and an external network is connected, the segment having a receiver terminal controlled by the gateway apparatus, wherein
said processor deletes, upon receiving a multicast stop request from the receiver terminal under control, an entry only when a participant having an identical entry does not exist on an interface that has received the multicast stop request, and wherein, after searching receiver information lists of all interfaces and when the identical entry is not found in the receiver information lists, said processor transmits a tunnel release request message to a sender gateway apparatus that has the sender terminal under control, the sender terminal being a source of a multicast packet.

10. A gateway apparatus comprising:
a memory that stores a control program;
a processor that retrieves the control program from said memory and executes the control program; and
a plurality of interfaces to which a segment and an external network is connected, the segment having a sender terminal controlled by the gateway apparatus, wherein said processor generates, upon receiving a tunnel connection request message, a tunnel interface having the receiver gateway apparatus as a destination, the receiver gateway apparatus being a source of the tunnel connection request message, and wherein said processor adds an entry to a multicast routing table, the entry also transmitting a multicast packet to a receiver gateway apparatus, the multicast packet having the sender terminal as a source address and the multicast address as a sending address.

11. A gateway apparatus comprising:
a memory that stores a control program;
a processor that retrieves the control program from said memory and executes the control program; and
a plurality of interfaces to which a segment and an external network is connected, the segment having a sender terminal controlled by the gateway apparatus, wherein said processor deletes, upon receiving a tunnel release request message, a tunnel interface having the receiver gateway apparatus as a destination, the receiver gateway apparatus being a source of the tunnel connection request message, and wherein
said processor deletes an entry to a multicast routing table, the entry also transmitting a multicast packet to a receiver gateway apparatus, the multicast packet having the sender terminal as a source address and the multicast address as a sending address.
